(19) United States
(12) Patent Application Publication
(10) Pub. No.: US 2014/0048197 A1
(43) Pub. Date: Feb. 20, 2014

(54) Method for Manufacturing a Lure

(71) Applicant: Harri Leppälä, Vaaksy (FI)

(72) Inventor: Harri Leppälä, Vaaksy (FI)

(21) Appl. No.: 13/983,202

(22) PCT Filed: Jan. 26, 2012
(86) PCT No.: PCT/FI2012/050069

§ 371 Date: Oct. 31, 2013

(30) Foreign Application Priority Data
Feb. 4, 2011 (FI) 20115116

(51) Int. Cl. A01K 85/16

(52) U.S. Cl. CPC A01K 85/16
USPC 156/60

(57) ABSTRACT

The invention concerns a method for manufacturing a lure. A lure body precisely matching the final shape and size of the lure is worked from wooden material and the lure body is outfitted. A plastic shell, in which the lure body is tightly enclosed, comprised of parts joinable by sealing, matching precisely the outer dimensions of the lure body, is also manufactured, and the lure is coated.

The object of the present invention is a method for manufacturing a lure having a wooden body.

Verified by long-term practice, a lure having a wooden body has properties, the imitation of which has not been sufficiently successful with lures having bodies of other materials. The most relevant of these hard-replicable properties is the swimming motion of the lure. A body with an advantageous shape/weight ratio, and therefore moment of inertia, can be manufactured from wood for enabling back and forth swimming motions that have been proven good. The correct shape/weight ratio, however, requires a light wood, traditionally balsa wood and apache wood.

The softness and low load resistance of light weight wood requires coating the lure with several layers of varnish in order to ensure a sufficient strength and water tightness (sandwich structure). A proper outcome requires several layers of varnish. Lacquering with varnishes suitable for the treatment of wood requires drying between the layers of varnish, for removing the solvents included in the varnishes. This results in the slowness of the manufacturing process as well as problems to the environment caused by the varnishes. For the coating phases and their waiting phases the lure bodies have to be equipped with suitable suspension grips extending in to the body itself.

Removed after the coating, the suspension grips leave holes in the finished coating, through which water can penetrate to be in contact with the body, in which it is absorbed with time. A lip, required in many types of lures is also problematic in terms of its attachment. It is usual that after the coating phase a groove extending to the body material is machined to the front portion of the lure body to receive a lip. The lip (commonly a separate plate-like part made to a specific form from a hard plastic) is attached to the groove using adhesive or another suitable fixing method. The attachment area of the lip causes problems in achieving a reliable seal. Mountings extending outside the coating, such as fishing line and hook fasteners, require a cleaning after the coating, where leak points are easily formed on the coating.

The manufacturing method according to the present invention strives to overcome these problems without the loss of the functional benefits of a traditional lure having a wooden body.

In the method, a lure body corresponding to the final shape and size of a lure is worked from wood material, which lure body is outfitted, meaning that at least the so-called mounting, i.e. hook fasteners, line fasteners and possible weights are attached to it. In the outfitting, a lip can optionally be attached to the body. When implementing the method, a plastic shell tightly enclosing the lure body and comprising of parts joinable together by sealing, is manufactured precisely according to the outer dimensions of the lure body.

The shell for the lure body is manufactured with manufacturing methods using a mould known as such for plastic products. Alternatives are, for example, injection moulding or vacuum forming. The shell is manufactured from a suitable plastic material, as a hard plastic product or from plasticized plastic. Suitable plastic types are e.g. ABS, PC, PS and PET. The thickness of the shell is selected to be as thin as possible, mainly so as to correspond to the thickness produced by varnish coatings currently in use. The shell can be made transparent or alternatively a coloring can be included in the plastic material, for example a suitable background coloring, which is supplemented with post-processing. Suitable color pigments not requiring hazardous solvent components can be used for the plastic surface in the post processing. If the shell parts are manufactured using vacuum forming, or a similar technique utilizing a single-surface mould, the color pattern of the lure can be applied to the sheet-like plastic material using printing techniques prior to the moulding phase. The color pattern can be produced on the surface that will be on the inside of the shell, or alternatively on the outside, in which case the transparency of the moulded material and the properties of the colors must be taken into account.

Plastic product manufacturing enables producing surface texture patterns to the lure, should this be seen necessary. Also various additional components can be manufactured to the shell, the most essential one being a lip manufactured as a part of the lure shell, as opposed to a lip mounted to the body. Also a hinge component in two part lures can be produced in connection with the manufacture of the plastic shell as a durable and functional structure.

Advantageously, the shell is manufactured as two mirrored halves, inside which the pre-shaped wooden body is placed either as received from a machining center for shaping, or lightly surface-treated, mainly for binding surface dust. The shell is made as precisely as possible to match the outer dimensions of the wooden body and is sealed around the body. The sealing is carried out using conventional joining methods such as adhesion, radiation heating, etc. In connection with the sealing, a slight bleeding can be done for sucking out any possible air from within the shell before closing the seal.

Outfitting components extending outside the shell, such as the line fastener and hook fasteners are advantageously located in the final lure at the seam area of the shell, whereby their interior tightness is secured as a byproduct from the sealing. The strength of the outfitting components' attachment can be enhanced if they run through the lure. For example, the line fastener is attached to the hook fastener with a reinforcement part running through the lure. Such reinforcement parts in the lure body can simply be located at the lure body seam. The body can be manufactured in, or split after manufacturing, for example, into two halves, on the dividing surfaces of which necessary routes for the reinforcement parts can be machined. The halves are joined together in connection with the sealing of the shell part. Handling the lure as two joinable parts also enables applying vacuum forming techniques to the coating of the body halves.

A fixing projection, or similar, from which the lure is suspended during post-processing phases and their holding positions, is manufactured to the plastic shell at a suitable location for carrying out the finishing treatments of the lure. This fixing projection is removed from an already treated lure. The removal does not leave an access route for water to the wooden body.

1-11. (canceled)

12. A method for manufacturing lures, comprising:
working a lure body from a wooden material;
outfitting the lure body with fittings protruding from the lure body; and
enclosing the lure body within a plastic shell, wherein the plastic shell comprises parts joinable by sealing, and wherein the plastic shell precisely matches the outer dimensions of the lure body.

13. The method according to claim 12, wherein the lure body is manufactured from balsa wood, apache wood or another suitable wood.

14. The method according to claim 1, wherein the plastic shell is manufactured from hard plastic.

15. The method according to claim 1, wherein the plastic shell is manufactured from plasticized plastic.

16. The method according to claim 1, wherein the plastic shell is manufactured to have a wall thickness corresponding to that achieved by layers of varnish.

17. The method according to claim 1, wherein the fittings protruding from the lure body are located along seam areas formed at junctions of the parts of the plastic shell.

18. The method according to claim 1, wherein the fittings protruding from the lure body extend through the plastic shell for achieving a greater strength.

19. The method according to claim 18, wherein a passage for the fittings is arranged at a dividing seam of the lure body.

20. The method according to claim 1, wherein inside surfaces of the plastic shell parts are coated before the lure is assembled.

21. The method according to claim 1, wherein the plastic shell is equipped with a fixing projection for post-processing of the lure.

22. The method according to claim 1, wherein the lure is bleeded from air in connection with joining the plastic shell.
